(19) United States
(12) Patent Application Publication
(10) Pub. No.: US 2005/0052104 A1
(43) Pub. Date: Mar. 10, 2005

(54) Infrared reflector and infrared radiator having such an infrared reflector

(75) Inventor: Hans-Joachim Schmidt, Ingolstadt (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 10/924,919

(22) Filed: Aug. 25, 2004

(30) Foreign Application Priority Data
Sep. 5, 2003 (DE) 103 41 503. 3

(51) Int. Cl. H01J 5/16; H01J 61/40; H01K 1/26; H01K 1/30

(52) U.S. Cl. 313/113; 313/110

(57) ABSTRACT

The invention relates to a reflector for infrared rays whose reflecting surface consists of copper, according to the invention. The invention also relates to an infrared radiator having an incandescent lamp as radiation source and a reflector having a reflecting surface made from copper.

### I. TECHNICAL FIELD

The invention relates to a reflector for infrared radiation having a surface reflecting infrared rays, wherein this surface consists of copper, and to an infrared radiator having such a reflector.

### II. BACKGROUND ART

Laid-open application EP 1 072 841 A2 describes an infrared radiator having an incandescent lamp as radiation source and a parabolic reflector that is of transparent design and reflects the infrared radiation in the desired direction. The reflector opening is covered by means of an opaque filter disk.

### III. DISCLOSURE OF THE INVENTION

It is the object of the invention to provide a reflector for infrared radiation and an infrared radiator having as simple a design as possible.

This object is achieved according to the invention by a reflector having a surface reflecting infrared rays, wherein this surface consists of copper. Particularly advantageous embodiments of the invention are described in the dependent patent claims.

According to the invention, the surface reflecting infrared rays consists of copper. The inventive reflector for radiation above a wavelength of 700 nm therefore has a reflectivity of more than 90%. In the wavelength region from 800 nm to 1500 nm the reflectivity is even more than 95% of the radiation striking the surface. In the wavelength region from 700 nm to 1500 nm the inventive reflector therefore has just as good reflectivity as known gold reflectors, but is much more cost-effective than a reflector coated with gold. The inventive reflector can be used with a halogen incandescent lamp particularly advantageously, since the halogen incandescent lamp outputs the greatest part of its energy in the form of infrared radiation above a wavelength of approximately 780 nm.

The inventive infrared radiator has a halogen incandescent lamp as radiation source and a reflector with a surface that consists of copper and reflects infrared rays. As already explained above, the combination of a halogen incandescent lamp and a reflector whose reflecting surface consists of copper results in a particularly efficient and cost-effective infrared radiator in the wavelength region from 700 nm to 1500 nm, since the halogen incandescent lamp emits the greatest part of its energy in the form of infrared radiation with wavelengths above 780 nm, and the copper surface of the reflector has a very high reflectivity of more than 95% of the incident radiation in the wavelength region from 800 nm to 1500 nm. In order to suppress the light emitted by the halogen incandescent lamp, the lamp vessel is advantageously provided with an optically reflecting coating transparent to infrared rays. For the same purpose, the reflector opening can be covered as an alternative or in addition by an opaque cover transparent to infrared radiation. In accordance with the preferred exemplary embodiment, the reflector is designed as a shell-shaped glass reflector whose inside is provided with a copper layer.

### IV. BRIEF DESCRIPTION OF THE DRAWINGS

The invention is explained in more detail below with the aid of a preferred exemplary embodiment. In the drawing:

FIG. 1 shows a partially sectioned side view of an infrared radiator in accordance with the preferred exemplary embodiment of the invention, and

FIG. 2 shows the reflectivity of the copper layer of the reflector of the infrared radiator in FIG. 1 as a function of the wavelength compared to a gold layer.

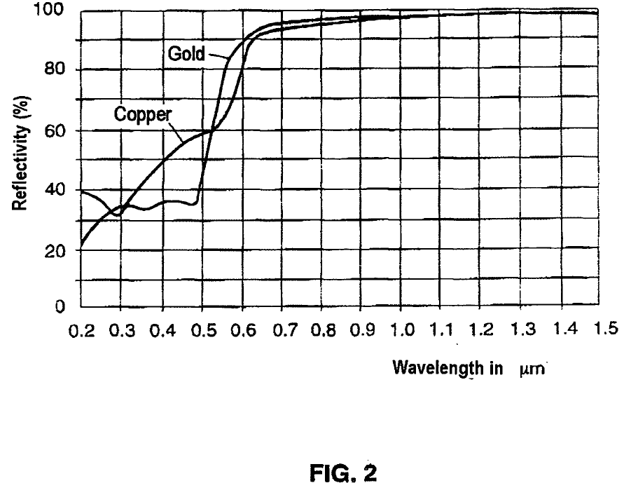

### V. BEST MODE FOR CARRYING OUT THE INVENTION

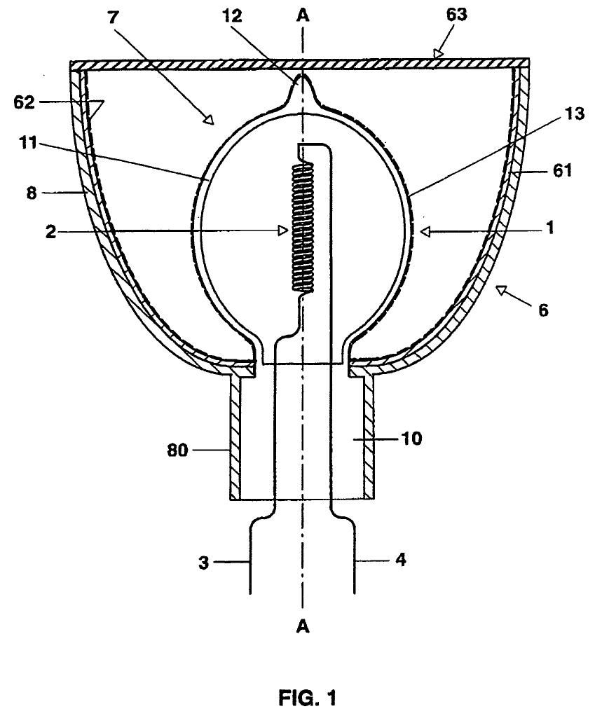

The infrared radiator illustrated in FIG. 1 has as radiation source a halogen incandescent lamp 1 having an electric power consumption of approximately 50 watts. It has a lamp vessel made from silica glass that is sealed at one end. Arranged in the interior of the lamp vessel is an incandescent filament 2 made from tungsten that is supplied with electric energy by means of two supply leads 3, 4 projecting from the sealed end 10 of the lamp vessel. The region 11 of the lamp vessel surrounding the incandescent filament 2 is coated with an interference filter 13 that is designed as a diathermic mirror, is transparent to infrared radiation, and retroreflects into the lamp vessel for the purpose of filament heating the light generated by the incandescent filament 2. The interference filter 13 also extends over the dome 12 of the lamp vessel.

The reflector 6 is designed as a parabolic glass reflector with a basic body 8 made from glass and whose inside has a copper layer 61 reflecting infrared radiation. Also applied to the copper layer 61 is a varnish layer 62 that is transparent to light and infrared rays and serves as protection against corrosion. The reflector opening is closed by an opaque cover disk 63 transparent to infrared rays. The sealed end 10 of the lamp vessel of the halogen incandescent lamp 1 is fixed in the reflector neck 80.

1. A reflector having a surface reflecting infrared rays, wherein this surface consists of copper.

2. An infrared radiator having a halogen incandescent lamp as radiation source and a reflector, wherein the reflector has a surface made from copper that reflects infrared rays.

3. The infrared radiator as claimed in claim 2, wherein the reflector opening is provided with an opaque cover.

4. The infrared radiator as claimed in claim 2, wherein the reflector is a shell-shaped glass reflector whose inside is provided with a copper layer.

5. The infrared radiator as claimed in claim 2, wherein the lamp vessel of the halogen incandescent lamp is provided with an optically reflecting coating transparent to infrared rays.
